(19) United States
(12) Patent Application Publication
(10) Pub. No.: US 2016/0055391 A1
(43) Pub. Date: Feb. 25, 2016

(54) METHOD AND APPARATUS FOR EXTRACTING A REGION OF INTEREST

(71) Applicant: Samsung Electronics Co., Ltd., Gyeonggi-do (KR)

(72) Inventor: Cheol Nyeon KIM, Daegu (KR)

(21) Appl. No.: 14/833,581

(22) Filed: Aug. 24, 2015

(30) Foreign Application Priority Data
Aug. 25, 2014 (KR) 10-2014-0111073

(51) Int. Cl. G06K 9/46; G06F 17/30; G06K 9/52; G06K 9/62

(52) U.S. Cl. CPC G06K 9/46; G06K 9/6267; G06F 17/30256; G06K 9/52; G06K 2009/4666

(57) ABSTRACT

An electronic device comprising: a display; and one or more processors configured to: display an image on the display; generate an object code associated with an object depicted in the image based on environment information associated with the image; identify a region of interest based on the object code; identify an information item associated with the region of interest; and output the information item.

### CLAIM OF PRIORITY

This application claims the benefit under 35 U.S.C. §119(a) of a Korean patent application filed on Aug. 25, 2014 in the Korean Intellectual Property Office and assigned Serial number 10-2014-0111073, the entire disclosure of which is hereby incorporated by reference.

### TECHNICAL FIELD

The present disclosure relates to an electronic devices, and more particularly to a method apparatus for extracting a region of interest.

### BACKGROUND

With the advancement of electronic devices, a user may not only use a communication function through various electronic devices (e.g., a smartphone, a tablet, a smart watch, and the like), but may also see pictures or videos through the various electronic devices. A user may take a picture of his/her target of interest or may download and store it. The user may see the picture as occasion demands.

Conventionally, the user's region of interest may be collected by providing a question and answer page associated with a region of interest to a user or by using keywords inputted by the user. However, this approach may be problematic in that it is difficult to practically apply user's regions of interest varying according to the lapse of time. Furthermore, since the above-described method fragmentarily extracts regions of interest and depends on selection or searching of a user, information not associated with an actual region of interest of the user may be provided to the user. For this reason, it may be difficult to effectively provide information, such as an advertisement, based on extracted regions of interest.

### SUMMARY

According to one aspect of the disclosure, an electronic device comprising: a display; and one or more processors configured to: display an image on the display; generate an object code associated with an object depicted in the image based on environment information associated with the image; identify a region of interest based on the object code; identify an information item associated with the region of interest; and output the information item.

According to another aspect of the disclosure, an electronic device comprising: a display; and one or more processors configured to: display an image on the display; generate an object code associated with an object depicted in the image based on environment information associated with the image; identify a region of interest based on the object code; identify an information item associated with the region of interest; and output the information item.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram of an example of a network environment, according to various embodiments of the present disclosure;

FIG. 2 is a block diagram illustrating an example of an extracting module architecture, according to various embodiments of the present disclosure;

FIG. 3 is a flowchart of an example of a process, according to various embodiments of the present disclosure;

FIG. 4 is a flowchart of an example of a process, according to various embodiments of the present disclosure;

FIG. 5 is a diagram illustrating a screen for generating an object code, according to various embodiments of the present disclosure;

FIG. 6 is a diagram illustrating an object code, according to various embodiments of the present disclosure;

FIG. 7 is a diagram of an example of a data structure, according to various embodiments of the present disclosure;

FIG. 8 is a diagram of an example of a system, according to various embodiments of the present disclosure; and

FIG. 9 is a diagram of an example of an electronic device, according to various embodiments of the present disclosure.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to the drawings, similar components may be marked by similar reference numerals.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof

The meaning of the term “or” or “at least one of A and/or B” used herein includes any combination of words listed together with the term. For example, the expression “A or B” or “at least one of A and/or B” may indicate A, B, or both A and B.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

Terms used in this specification are used to describe embodiments of the present disclosure and are not intended to limit the scope of the present disclosure. The terms of a singular form may include plural forms unless otherwise specified.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

Electronic devices according to various embodiments of the present disclosure may include an electronic device having a communication function. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances including a communication function. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

According to various embodiments of the present disclosure, the electronic devices may include at least one of medical devices (e.g., a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), and points of sales (POSs).

According to various embodiments of the present disclosure, the electronic devices may include at least one of parts of furniture or buildings/structures having communication functions, electronic boards, electronic signature receiving devices, projectors, and measuring instruments (e.g., water meters, electricity meters, gas meters, and wave meters) including metal cases. The electronic devices according to various embodiments of the present disclosure may be one or more combinations of the above-mentioned devices. Furthermore, the electronic devices according to various embodiments of the present disclosure may be flexible devices. It would be obvious to those skilled in the art that the electronic devices according to various embodiments of the present disclosure are not limited to the above-mentioned devices.

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

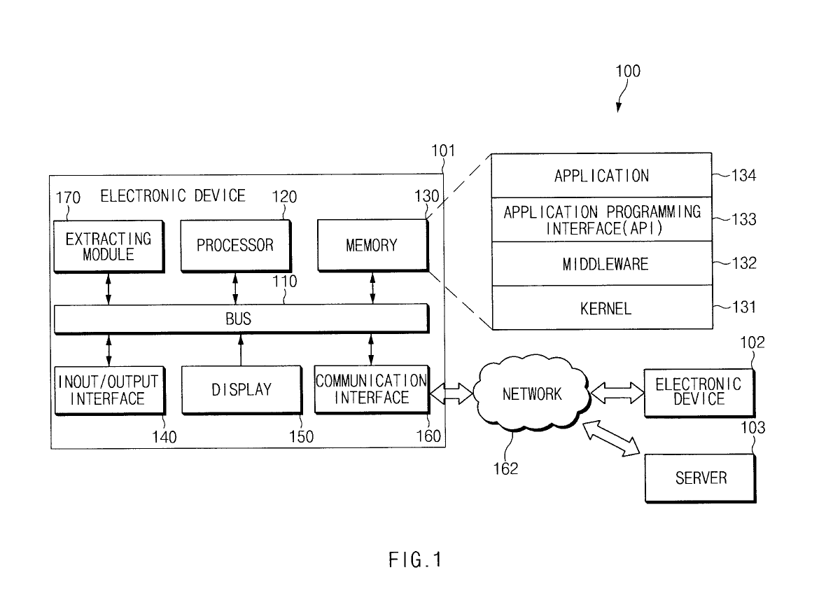

FIG. 1 is a diagram of an example of a network environment, according to various embodiments of the present disclosure.

Referring to FIG. 1, an electronic device 101 may include a bus 110, a processor 120, a memory 130, an input/output interface 140, a display 150, a communication interface 160, and an extracting module 170. According to various embodiments of the present disclosure, the electronic device 101 may code and manage storage information, reading information, image processing information, and the like on a picture which a user selects (or enlarges) through the display 150. The electronic device 101 may analyze the coded information to identify a region that is of interest to the user. According to various embodiments of the present disclosure, the electronic device 101 may provide additional information to the user based on the extracted region of interest, thereby improving user convenience.

The bus 110 may interconnect the above-described components and may be a circuit for conveying communications (e.g., a control message) among the above-described components.

The processor 120 may include any suitable type of processing circuitry, such as one or more general purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. In operation, the processor 120 may receive, for example, instructions from the above-described other components (e.g., the memory 130, the input/output interface 140, the display 150, the communication interface 160, the extracting module 170, and the like) through the bus 110, may decode the received instructions, and may perform data processing or operations according to the decoded instructions.

The memory 130 may include any suitable type of volatile or non-volatile memory, such as Random Access Memory (RAM), Read-Only Memory (ROM), Network Accessible Storage (NAS), cloud storage, a Solid State Drive (SSD), etc. In operation, the memory 130 may store instructions or data received from the processor 120 or other components (e.g., the input/output interface 140, the display 150, the communication interface 160, the extracting module 170, and the like) or generated by the processor 120 or the other components.

According to various embodiments of the present disclosure, the memory 130 may store data (hereinafter referred to as “picture data”) of a captured or downloaded picture(s). The picture data may be captured by an embedded camera of the electronic device 101 or may be downloaded and stored on an external device. In instances in which a user selects (or enlarges) the stored picture data, selection (or enlargement) information such as a reading time and the like may be used to determine a user's region of interest.

According to various embodiments of the present disclosure, the memory 130 may include, for example, programming modules such as a kernel 131, a middleware 132, an application programming interface (API) 133, an application 134, and the like. Each of the above-described programming modules may be implemented in the form of software, firmware, hardware, or a combination of at least two thereof.

The kernel 131 may control or manage system resources (e.g., the bus 110, the processor 120, the memory 130, and the like) that are used to execute operations or functions of remaining other programming modules, for example, the middleware 132, the API 133, or the application 134. Furthermore, the kernel 131 may provide an interface that allows the middleware 132, the API 133, or the application 134 to access discrete components of the electronic device 101 so as to control or manage the middleware 132, the API 133, or the application 134.

The middleware 132 may perform a mediation role such that the API 133 or the application 134 communicates with the kernel 131 to exchange data. Furthermore, with regard to task requests received from the application 134, for example, the middleware 132 may perform a control (e.g., scheduling or load balancing) on a task request using a method of assigning the priority, which makes it possible to use a system resource (e.g., the bus 110, the processor 120, the memory 130, or the like) of the electronic device 101, to the at least one application 134.

The API 133 may be an interface through which the application 134 controls a function provided by the kernel 131 or the middleware 132, and may include, for example, at least one interface or function (e.g., an instruction) for a file control, a window control, image processing, a character control, or the like.

According to various embodiments of the present disclosure, the application 134 may include a gallery application capable of checking stored picture data. Additionally or generally, the application 134 may be an application associated with information exchange between the electronic device 101 and an external electronic device (e.g., an electronic device 102 or a server 103). The application associated with information exchange may include, for example, a notification relay application for transmitting specific information to an external electronic device or a device management application for managing an external electronic device.

The I/O interface 140 may transmit an instruction or data, input from a user through an input/output device (e.g., a sensor, a keyboard, or a touch screen), to the processor 120, the memory 130, the communication interface 160, or the message management unit 170, for example, through the bus 110. For example, the I/O interface 140 may provide the processor 120 with user's touch data input through a touch screen. Furthermore, the I/O interface 140 may output an instruction or data, received from the processor 120, the memory 130, the communication interface 160, or the message management unit 170 through the bus 110, through the input/output device (e.g., a speaker or a display). For example, the I/O interface 140 may output voice data through a speaker.

The display 150 may display a variety of information (e.g., multimedia data, text data, and the like) for the user. According to various embodiments of the present disclosure, the display 150 may output a picture selected by a user. An object(s) included in the output picture may be recognized through various image processing techniques.

The communication interface 160 may establish communication between the electronic device 101 and an external electronic device (e.g., an electronic device 104 or a server 106). For example, the communication interface 160 may be connected to a network 162 through wireless communication or wired communication to communicate with the external electronic device. The wireless communication may include at least one of, for example, wireless-fidelity (Wi-Fi), Bluetooth (BT), near field communication (NFC), global positioning system (GPS), or cellular communication (e.g., 3G, LTE, LTE-A, CDMA, WCDMA, UMTs, WiBro, GSM, or the like). Furthermore, the communication interface 160 may include at least one of a universal serial bus (USB), a high definition multimedia interface (HDMI), a recommended standard 232 (RS-232), or a plain old telephone service (POTS).

According to an embodiment, the network 162 may be a telecommunications network. The telecommunications network may include at least one of a computer network, an internet, an internet of things, or a telephone network. According to an embodiment of the present disclosure, a protocol (e.g., a transport layer protocol, a data link layer protocol, or a physical layer protocol) for communication between the electronic device 101 and an external device may be supported by at least one of the kernel 131, the middleware 132, the application programming interface 133, the application 134, or the communication interface 160.

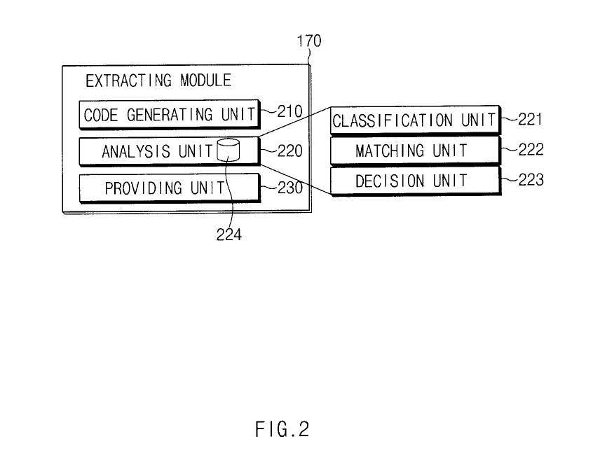

If picture data stored in the memory 130 is selected by a user, the extracting module 170 may extract a region that is of interest to the user based on selection (or enlargement) information (e.g., a selection (or enlargement) time, a selection (or enlargement) interval, and the like). The extracting module may determine an actual region that is of interest to the user by using selection (or enlargement) information, image information, file storage information, or the like. The extracting module may provide the user with information customized according to the determined region of interest. A configuration of the extracting module will be described with reference to FIG. 2.

In FIG. 1, an embodiment of the present invention is exemplified as the extracting module 170 is independent of the processor 120. However, the scope and spirit of the present disclosure may not be limited thereto. For example, the extracting module 170 may be implemented with a portion of the processor 120.

FIG. 2 is a block diagram illustrating an example of an extracting module architecture, according to various embodiments of the present disclosure.

Referring to FIG. 2, an extracting module 170 may include a code generating unit 210, an analysis unit 220, and a providing unit 230. The units 210-230 may be classified according to functions. However, the scope and spirit of the present disclosure may not be limited thereto. According to various embodiments of the present disclosure, the units 210-230 may be either integrated together into a single entity or implemented separately from one another. The units 210-230 may be implemented using one or more processors and/or other requisite hardware.

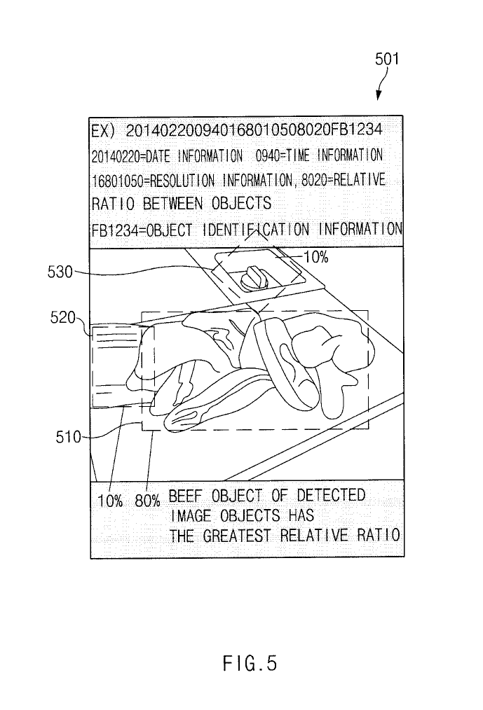

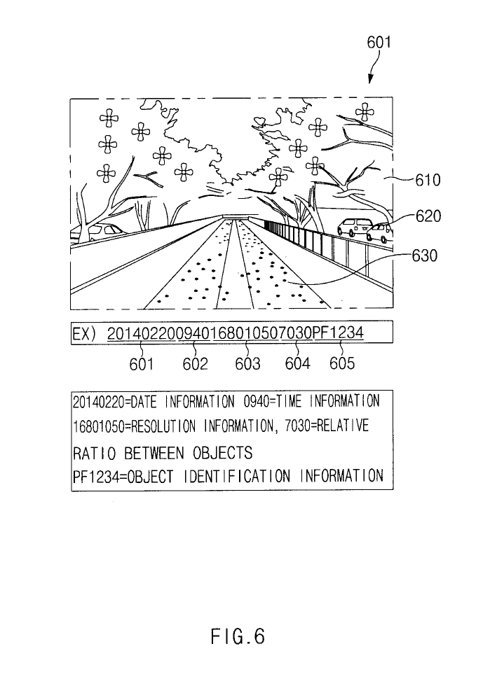

In instances in which a user selects (or enlarges) a picture stored in the memory 130, the code generating unit 210 may collect information associated with the picture to generate an object code. The object code may include information (hereinafter referred to as “object information”) of an object being a subject (e.g., person, flower, animal, thing, and the like) included in the picture and information (hereinafter referred to as “environment information”) associated with selecting and storing of the picture. According to various embodiments of the present disclosure, the object code may include a numerical and/or alphanumerical string, a bar code, and/or any other suitable type of identifier. The data size of the object code may be smaller than that of a picture file. Information associated with the object code may be described with reference to FIG. 5 or 6.

The analysis unit 220 may analyze an object code generated by the code generating unit 210 to identify the user's region of interest. The analysis unit 220 may include a classification unit 221, a matching unit 222, a decision unit 223, and database 224.

The classification unit 221 may parse and classify an object code received from the code generating unit 210 into a category. For example, the classification unit 221 may classify an object code into a selection (or enlargement) time, duration, whether or not of enlargement, an object ratio, object identification information, and the like, based on a predetermined reference. The classification unit 221 may allocate reference information (e.g., object identification information) of the classified information and may store the classified information in the database 224 in connection with the reference information.

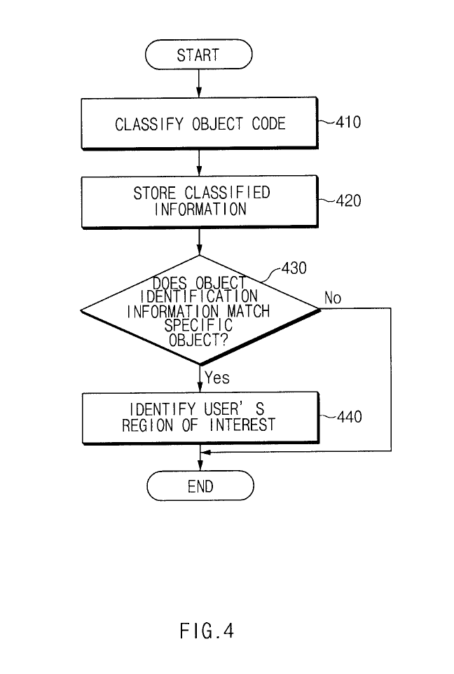

According to various embodiments of the present disclosure, the matching unit 222 may match object identification information with a specific object (an object including additional information provided by the providing unit 230). Through a matching operation, the matching unit 222 may prevent the decision unit 223 from extracting a region of interest repeatedly or from extracting an interest index on a region where it is impossible to provide information. Additional information associated with an operation of the matching unit 222 may be described with reference to FIG. 4.

Based on information associated with a region of interest stored in the database 224, the decision unit 223 may identify a current region of interest or may check a variation in a region of interest. According to various embodiments of the present disclosure, the decision unit 223 may assess the user's level of interest in the object (or a region in which an object is included), based on the number of times the user selects the object, an enlargement time, a selection interval, an area ratio of an object to a picture, and the like. If the level (or the level of interest) is greater than or equal to a specific value, the decision unit 223 may select a corresponding region as the user's region of interest and may provide additional information on the region of interest to the providing unit 230.

The database 224 may store information classified by the classification unit 221. The database 224 may store the classified information in connection with reference information (e.g., object identification information). For example, the database 224 may store the following information based on the object identification information (e.g., beef, FB1234, and the like): an enlargement time, a selection period, whether or not of enlargement, and the like. According to various embodiments of the present disclosure, the database 224 may be implemented with a portion of a memory 130 illustrated in FIG. 1. The providing unit 230 may provide a user or an external device (e.g., an electronic device 102 or a server 103) with additional information associated with a region of interest or a level of interest identified by the analysis unit 220. For example, if a selection count on a picture including “beef” increases (or a selection period decreases), an analysis result of the analysis unit 220 may indicate that the user's interest index associated with a region, such as beef/meet/food and the like including “beef”, becomes higher. The providing unit 230 may provide information (e.g., information of a famous restaurant associated with beef or information of a festival associated with beef) associated with a region of which the interest index increases. According to various embodiments of the present disclosure, the providing unit 230 may provide an external server (e.g., a server 103) with information associated with the user's region of interest. The external server may provide a user with customized information (e.g., beef purchasing information, information on how to cook beef, and the like) associated with the region of interest.

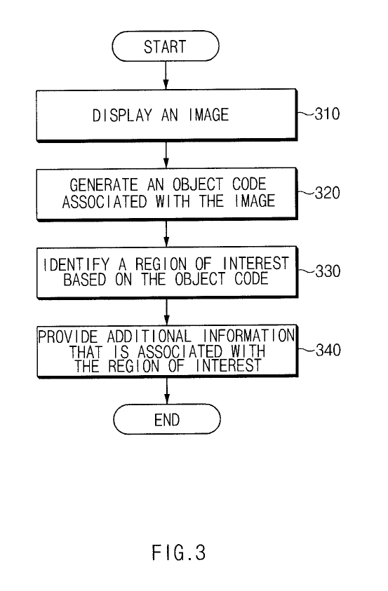

FIG. 3 is a flowchart of an example of a process, according to various embodiments of the present disclosure.

Referring to FIG. 3, in operation 310, if a user selects (or enlarges) a stored picture, a processor 120 may output the picture through a display 150. The picture may be captured with a camera included in an electronic device 101 or may be downloaded from an external device (e.g., an electronic device 102 or a server 103) and may be then stored in a memory 130. For example, the user may execute the album app to select and enlarge one of a plurality of images.

In operation 320, a code generating unit 210 may generate an object code based on object information and environment information of a picture viewed by a user. The object code may include a numerical and/or alphanumerical string, a bar code, and/or any other suitable type of identifier. For example, the object code may be a text obtained by concatenating an indication of an enlargement time, an indication of an object ratio, and identifier corresponding to the object, and the like.

According to various embodiments of the present disclosure, the object information may include recognition information associated with an object (e.g., person, flower, animal, and the like) included in the picture. The object may be a subject expressed to such an extent as to be recognizable through an image processing technique or may be a subject taking a picture above a specific range. The code generating unit 210 may use a variety of image processing techniques to extract object information. A method for extracting object information to generate an object code will be described with reference to FIGS. 5 and 6.

According to various embodiments of the present disclosure, the environment information may include the following information associated with selection (or enlargement) of a user: an enlargement time, selection (or enlargement) duration, whether or not of picture enlargement, and the like. Furthermore, the environment information may include the following information associated with saving of a picture file: time when a picture is saved, resolution set in saving a picture, file type, and the like.

According to various embodiments of the present disclosure, in instances in which a picture stored in the memory 130 is deleted by a user, the environment information may include deletion information. The deletion information may be provided to an analysis unit 230 so as to be applied to identify the user's region of interest. For example, in instances in which a first picture (e.g., a landscape picture including flowers) is deleted by a user, the analysis unit 220 may identify an object (e.g., flowers) included in the first picture as and may decrease an interest index associated with the object.

In operation 330, the analysis unit 220 may analyze one or more object codes associated with the image that are generated by the code generating unit 210 to identify the user's region of interest. According to various embodiments of the present disclosure, the analysis unit 220 may include a classification unit 221, a decision unit 223, and database 224. The classification unit 221 may parse and classify an object code received from the code generating unit 210 and may store the parsed and classified result in the database 224. The decision unit 223 may identify a current region of interest or interest index of a user, based on information on the user stored in the database 224.

According to various embodiments of the present disclosure, in operation 340, the providing unit 230 may identify additional information associated with a region of interest or an interest index identified by the analysis unit 220. After the additional information is identified, it may be output by displaying the additional information on a display screen and/or transmitting the additional information over a communications network to another device or server.

More particularly, in some implementations, the providing unit 230 may identify the additional information based on a data structure (e.g., a table) that relates different types of additional information with different ranges of an interest index that correspond to different categories. For example, the data structure may provide information of a relatively narrow range, such as basic information or surrounding information, with respect to a first range (e.g., an interest index being greater than or equal to 10 and smaller than 50) and may provide information of a relatively wide range, such as event information or festival information, with respect to a second section (e.g., an interest index being greater than or equal to 50 and smaller than 100).

FIG. 4 is a flowchart of an example of a process, according to various embodiments of the present disclosure.

Referring to FIG. 4, in operation 410, a classification unit 221 may parse and classify an object code received from a code generating unit 210. In operation 420, the classification unit 221 may store the classified information at database 224 in connection with reference information (e.g., object identification information).

In operation 430, a matching unit 222 may check whether object identification information of the classified information is matched with a predetermined object (e.g., an object having additional information to be provided from a providing unit 230). For example, the matching unit 222 may check whether the object is included in a specific object list. Through a matching operation, the matching unit 222 may allow the decision unit 223 to identify a level of interest of a user within objects included in a predetermined list. The matching unit 222 may prevent the decision unit 223 from extracting a region of interest repeatedly or from extracting an interest index on a region where it is impossible to provide information.

In operation 440, instances in which object identification information is matched with a predetermined object, the decision unit 223 may identify a current region of interest (or interest index), based on information on a region of interest stored in database 224.

For example, instances in which an electronic device 101 is driven in connection with a server which provides information associated with food, the matching unit 222 may allow the decision unit 223 to identify the user's region of interest if an object code includes foods such as beef, hamburger, cola, and the like. Furthermore, the matching unit 222 may stop deciding the user's region of interest if an object code includes persons or vehicles not associated with a food category.

According to various embodiments of the present disclosure, a region of interest extracting method may include outputting a picture selected by a user, generating an object code based on object information and environment information of the output picture, deciding a region of interest of the user by analyzing the object code, and providing information associated with the identified region of interest.

According to various embodiments of the present disclosure, the generating may include recognizing an object through an image processing technique and allocating specific object identification information to the recognized object. The deciding may include classifying the objected code to store the classified result in the database and deciding a region of interest of the user based on information stored in the database.

According to various embodiments of the present disclosure, a region of interest extracting method executed by one or more processors may include receiving an object code including object information and environment information associated with picture selection of a user, deciding a region of interest of the user by analyzing the object code, and providing the electronic device with information associated with the identified region of interest.

FIG. 5 is a diagram schematically illustrating a screen for generating an object code, according to various embodiments of the present disclosure.

Referring to FIG. 5, instances in which a user selects (or enlarges) a picture 501 stored in a memory 130, a code generating unit 210 may collect information associated with the picture 501 to generate an object code. The object code may be recognition information associated with an object (e.g., person, flow, animal, and the like) included in the picture.

According to various embodiments of the present disclosure, the code generating unit 210 may use various image processing techniques to extract object information. For example, the code generating unit 210 may recognize an object through the following techniques: 1) a method for recognizing an object in a probability modeling manner, 2) a method for recognizing an object through database in which a spatial relationship between objects is instanced, 3) a method for recognizing an object by extracting feature points of an object included in the picture and comparing the extracted feature points with previously stored feature points of an object. However, the scope and spirit of the present disclosure may not be limited thereto. For example, a variety of image processing techniques may be used.

According to various embodiments of the present disclosure, the code generating unit 210 may manage separate databases for different image processing techniques. For example, the database may include person recognition information associated with entertainers or famous persons. The code generating unit 210 may recognize an object by comparing information collected from the picture with a reference value stored in the database.

According to various embodiments of the present disclosure, instances in which the picture which a user intends to select is previously viewed and a history of a recognized object(s) exists, the code generating unit 210 may fetch and use previously processed information.

If recognizing first to third objects 510 to 530 through the image processing technique, the code generating unit 210 may allocate previously stored object identification information to each of the objects 510 to 530. For example, if the first object 510 is recognized as “beef”, the code generating unit 210 may allocate object identification information of “FB1234” on the beef to the first object 510. According to various embodiments of the present disclosure, the code generating unit 210 may collect ratio information on each of the first to third objects 510 to 530. The ratio information may include a ratio of an object to the whole picture (e.g., a first object: 48%, a second object: 8%, and a third object: 8%) or a relative ratio between objects (e.g., a first object: 80%, a second object: 10%, and a third object: 10%). The code generating unit 210 may process the ratio information so as to be included in the object code. The ratio information may be used in the process of deciding a region of interest.

The code generating unit 210 may generate an object code by arranging information associated with each object in a predetermined order. For example, the code generating unit 210 may generate an object code (e.g., 201402200940/16801050/8020/FB1234) by sequentially arranging date information, time information, resolution information, ratio information, and object identification information on a first object 510. An object code of a second object 520 or a third object 530 may be identified in a similar manner.

According to various embodiments of the present disclosure, the code generating unit 210 may be configured to generate an object code only with respect to an object (e.g., a first object 510) having the greatest area ratio or an object (e.g., an object having a relative area ratio greater than or equal to 40%) only with respect to an object having an area ratio greater than or equal to a specific area ration. This may be to apply that an object having a wider area in a picture is capable of becoming a major region of interest.

According to various embodiments of the present disclosure, the code generating unit 210 may collect information for generating an object code through a gallery application or may collect the information through another application to be executed in connection with the gallery application. For example, in the case of using a object recognition app, the object recognition app may be automatically executed if a user executes a gallery app, thereby making it possible to recognize an object in a picture.

FIG. 6 is a diagram schematically illustrating an object code according to various embodiments of the present disclosure.

Referring to FIG. 6, a code generating unit 210 may recognize first to third objects 610 to 630 using a variety of image processing techniques. The code generating unit 210 may allocate predetermined object identification information to each object. For example, instances in which the first object 610 is recognized as “cherry blossoms”, the code generating unit 210 may allocate “PF1234” being predetermined object identification information on “cherry blossoms” to the first object 610.

According to various embodiments of the present disclosure, the object identification information may be implemented in the form of combination of a letter indicating a category or a division of an object, and a unique identification letter of an object. For example, object identification information of “cherry blossoms” as the first object 610 may be formed of a combination of “PF” being letters indicating a category and a division of plant and flower and “1234” being unique identification letters corresponding to “cherry blossoms”. The code generating unit 210 may classify objects based on a classification system such as a biological classification system and may allocate a specific code thereto.

According to various embodiments of the present disclosure, the code generating unit 210 may generate an object code (e.g., 20140220/0940/16801050/7030/PF1234) by combing date information 601 (e.g., 20140220), time information 602 (e.g., 0940), resolution information 603 (e.g., 16801050), ratio information 604 (e.g., 7030), and object identification information 605 (e.g., PF1234). A classification unit 221 which receives the object code may previously store information associated with the generation of the object code. The classification unit 221 may parse and classify the object code based on the information and may store the parsed and classified result.

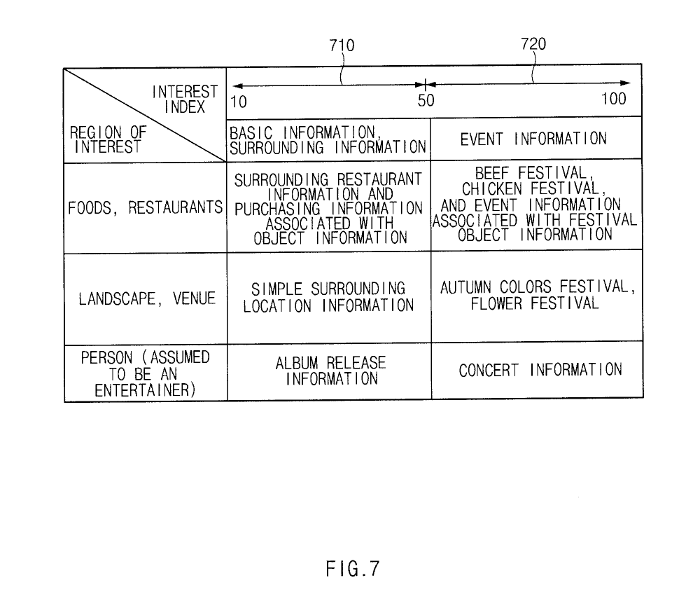

FIG. 7 is a diagram of an example of a data structure, according to various embodiments of the present disclosure.

Referring to FIG. 7, a providing unit 230 may provide a user or an external device (e.g., an electronic device 102 or a server 103) with additional information according to a region of interest or interest index identified by an analysis unit 220. The providing unit 230 may receive information the user's region of interest or interest index from a classification unit 220 in real time and may provide customized information associated with a current interest field of a user.

According to various embodiments of the present disclosure, the providing unit 230 may set a plurality of sections based on a variation in an interest index and may allocate information associated with an object to each section. For example, the providing unit 230 may classify an interest index into a first range 710 (e.g., an interest index being greater than or equal to 10 and smaller than 50) or into a second range 720 (e.g., an interest index being greater than or equal to 50 and smaller than 100) and may provide basic information (e.g., a surrounding famous restaurant) with respect to the first range 710 having a relatively low interest index, and event information (e.g., information associated with beef festival, pizza festival, and the like) with respect to the second range 720 having a relatively high interest index, respectively.

Alternatively, the providing unit 230 may provide basic information (e.g., album release information if the person is a singer) with respect to the first range 710 having a relatively low interest index and may provide event information (e.g., concert information of the person) with respect to the second range 720 having a relatively high interest index.

A table of FIG. 7 may be exemplary, not limited thereto. According to various embodiments of the present disclosure, the providing unit 230 may provide basic information (e.g., famous restaurant with delicious food) with respect to the first range 710 and may provide specialized information (e.g., famous restaurant with hot source) with respect to the second range 720.

According to various embodiments of the present disclosure, the providing unit 230 may provide an external server (e.g., an advertisement server) with information associated with the user's region of interest or interest index to allow additional information (e.g., advertisement of a product associated with a region of interest) specialized to a user to be sent through the external server.

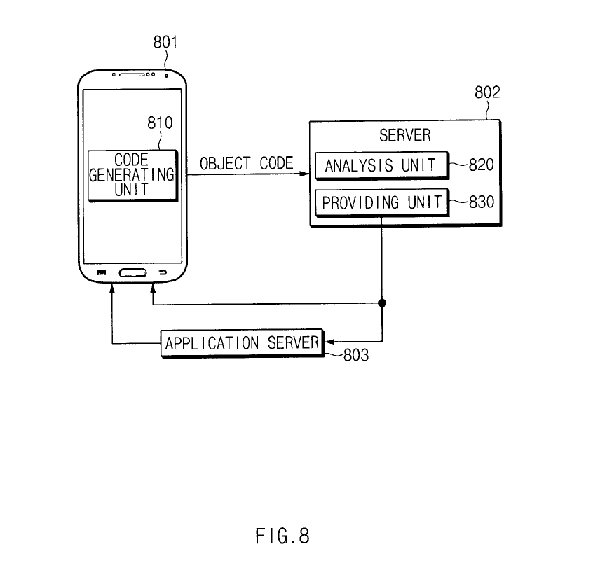

FIG. 8 is a diagram of an example of a system, according to various embodiments of the present disclosure.

Referring to FIG. 8, an electronic device 801 may include a code generating unit 810. The code generating unit 810 may be implemented using one or more processors of the device 801. In instances in which a user selects (or enlarges) a picture, the electronic device 801 may collect information associated with the picture to generate an object code through the code generating unit 810. The object code may include a numerical and/or alphanumerical string, a bar code, and/or any other suitable type of identifier.

The electronic device 801 may transmit the generated object code to an external server 802. The electronic device 801 may transmit not a picture but an object code, thereby improving data transmission speed or processing speed.

The server 802 may include an analysis unit 820 and a providing unit 830. The analysis unit 810 and the providing unit 820 may be implemented by using one or more processors of the server. The server 802 may identify a region of interest or interest index of a user, which uses the electronic device 801, based on the object code received from the electronic device 801. According to various embodiments of the present disclosure, the analysis unit 820 may include a classification unit, a matching unit, a decision unit, and database. A method for deciding a region of interest using such components may be substantially the same or similar to that described with reference to FIGS. 1 to 7.

The providing unit 830 may provide the electronic device 801 with additional information according to a region of interest or interest index identified through the analysis unit 820. The providing unit 830 may provide substantially associated information based on a current region of interest or interest level of a user.

According to various embodiments of the present disclosure, the providing unit 830 may provide an application server 803 (e.g., an advertisement server) with information associated with a region of interest or interest index identified through the analysis unit 820. The application server 803 may perform one-to-one marketing on a product associated with a substantial field of interest of a user, based on the information. Furthermore, the application server 803 may manage interest information associated with various users using separate databases and may use it for B2B marketing.

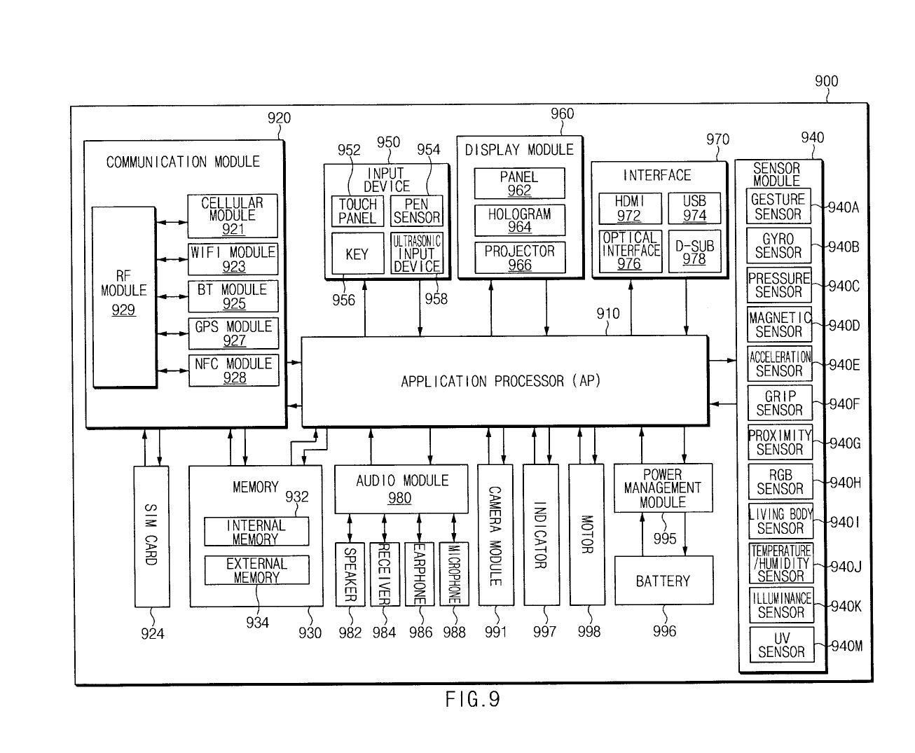

FIG. 9 is a diagram of an example of an electronic device 901 according to various embodiments of the present disclosure.

Referring to FIG. 9, an electronic device 901 may include one or more application processors (AP) 910, a communication module 920, a subscriber identification module (SIM) card 924, a memory 930, a sensor module 940, an input device 950, a display 960, an interface 970, an audio module 980, a camera module 991, a power management module 995, a battery 996, an indicator 997, and a motor 998.

The AP 910 may drive an operating system (OS) or an application to control a plurality of hardware or software components connected to the AP 910 and may process and compute a variety of data including multimedia data. The AP 910 may be implemented with a System on Chip (SoC), for example. According to an embodiment of the present disclosure, the AP 910 may further include a graphic processing unit (GPU) (not illustrated).

The communication module 920 may transmit and receive data when there are conveyed communications between other electronic devices connected with the electronic device 901 through a network. According to an embodiment of the present disclosure, the communication module 920 may include a cellular module 921, a wireless-fidelity (Wi-Fi) module 923, a Bluetooth (BT) module 925, a global positioning system (GPS) module 927, a near field communication (NFC) module 928, and a radio frequency (RF) module 929.

The cellular module 921 may provide voice communication, video communication, a character service, an Internet service or the like through a communication network (e.g., an LTE, an LTE-A, a CDMA, a WCDMA, a UMTS, a WiBro, a GSM, or the like). Also, the cellular module 921 may perform discrimination and authentication of an electronic device within a communication network using a subscriber identification module (e.g., a SIM card 924), for example. According to an embodiment of the present disclosure, the cellular module 921 may perform at least a portion of functions that the AP 910 provides. For example, the cellular module 921 may perform at least a portion of a multimedia control function.

According to an embodiment of the present disclosure, the cellular module 921 may include a communication processor (CP). Also, the cellular module 921 may be implemented with, for example, a SoC. Although components such as the cellular module 921 (e.g., a communication processor), the memory 930, the power management module 995, and the like are illustrated as being components independent of the AP 910, the AP 910 may be implemented to include at least a portion (e.g., a cellular module 921) of the above components.

According to an embodiment of the present disclosure, the AP 910 or the cellular module 921 (e.g., a communication processor) may load and process an instruction or data received from nonvolatile memories respectively connected thereto or from at least one of other elements at the nonvolatile memory. Also, the AP 910 or the cellular module 921 may store data received from at least one of other elements or generated by at least one of other elements at a nonvolatile memory.

Each of the Wi-Fi module 923, the BT module 925, the GPS module 927, and the NFC module 928 may include a processor for processing data exchanged through a corresponding module, for example. In FIG. 9, an embodiment of the present disclosure is exemplified as the cellular module 921, the Wi-Fi module 923, the BT module 925, the GPS module 927, and the NFC module 928 are separate blocks, respectively. According to an embodiment of the present disclosure, at least a portion (e.g., two or more components) of the cellular module 921, the Wi-Fi module 923, the BT module 925, the GPS module 927, and the NFC module 928 may be included within one Integrated Circuit (IC) or an IC package. For example, at least a portion (e.g., a communication processor corresponding to the cellular module 921 and a Wi-Fi processor corresponding to the Wi-Fi module 923) of communication processors corresponding to the cellular module 921, the Wi-Fi module 923, the BT module 925, the GPS module 927, and the NFC module 928 may be implemented with one SoC.

The RF module 929 may transmit and receive data, for example, an RF signal. Although not illustrated, the RF module 929 may include a transceiver, a power amplifier module (PAM), a frequency filter, or low noise amplifier (LNA). Also, the RF module 929 may further include the following part for transmitting and receiving an electromagnetic wave in a space in wireless communication: a conductor or a conducting wire. In FIG. 9, an embodiment of the present disclosure is exemplified as the cellular module 921, the Wi-Fi module 923, the BT module 925, the GPS module 927, and the NFC module 928 are implemented to share one RF module 929. According to an embodiment of the present disclosure, at least one of the cellular module 921, the Wi-Fi module 923, the BT module 925, the GPS module 927, or the NFC module 928 may transmit and receive an RF signal through a separate RF module.

The SIM card 924 may be a card that includes a subscriber identification module and may be inserted into a slot formed at a specific position of the electronic device. The SIM card 924 may include one or more unique identifiers (e.g., integrated circuit card identifier (ICCID)) or subscriber information (e.g., integrated mobile subscriber identity (IMSI)).

The memory 930 (e.g., the memory 730) may include an embedded memory 932 or an external memory 934. For example, the embedded memory 932 may include at least one of a volatile memory (e.g., a dynamic random access memory (DRAM), a static RAM (SRAM), or a synchronous DRAM (SDRAM)) and a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment of the present disclosure, the internal memory 932 may be a solid state drive (SSD). The external memory 934 may include a flash drive, for example, compact flash (CF), secure digital (SD), micro secure digital (Micro-SD), mini secure digital (Mini-SD), extreme digital (xD) or a memory stick. The external memory 934 may be functionally connected to the electronic device 901 through various interfaces. According to an embodiment of the present disclosure, the electronic device 901 may further include a storage device (or a storage medium), such as a hard drive.

The sensor module 940 may measure a physical quantity or may detect an operation state of the electronic device 901. The sensor module 940 may convert the measured or detected information to an electric signal. The sensor module 940 may include at least one of a gesture sensor 940A, a gyro sensor 940B, a pressure sensor 940C, a magnetic sensor 940D, an acceleration sensor 940E, a grip sensor 940F, a proximity sensor 940G, a color sensor 940H (e.g., red, green, blue (RGB) sensor), a living body sensor 9401, a temperature/humidity sensor 940J, an illuminance sensor 940K, or an UV sensor 940M. Although not illustrated, additionally or generally, the sensor module 940 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 940 may further include a control circuit for controlling at least one or more sensors included therein.

The input device 950 may include a touch panel 952, a (digital) pen sensor 954, a key 956, or an ultrasonic input unit 958. The touch panel 952 may recognize a touch input using at least one of capacitive, resistive, infrared and ultrasonic detecting methods. Also, the touch panel 952 may further include a control circuit. In the case of using the capacitive detecting method, a physical contact recognition or proximity recognition may be allowed. The touch panel 952 may further include a tactile layer. In this case, the touch panel 952 may provide a tactile reaction to a user.

The (digital) pen sensor 954 may be implemented in a similar or same manner as the method of receiving a touch input from a user or may be implemented using an additional sheet for recognition. The key 956 may include, for example, a physical button, an optical key, a keypad, and the like. The ultrasonic input device 958, which is an input device for generating an ultrasonic signal, may enable the electronic device 901 to detect a sound wave through a microphone (e.g., a microphone 988) so as to identify data, wherein the ultrasonic input device 958 is capable of wireless recognition. According to an embodiment the present disclosure, the electronic device 901 may use the communication module 920 so as to receive a user input from an external device (e.g., a computer or server) connected to the communication module 920.

The display 960 (e.g., a display 750) may include a panel 962, a hologram device 964, or a projector 966. The panel 962 may be, for example, a liquid crystal display (LCD), an active matrix organic light-emitting diode (AM-OLED, or the like. The panel 962 may be, for example, flexible, transparent or wearable. The panel 962 and the touch panel 952 may be integrated into a single module. The hologram device 964 may display a stereoscopic image in a space using a light interference phenomenon. The projector 966 may project light onto a screen so as to display an image. The screen may be arranged in the inside or the outside of the electronic device 901. According to an embodiment of the present disclosure, the display 960 may further include a control circuit for controlling the panel 962, the hologram device 964, or the projector 966.

The interface 970 may include, for example, an HDMI (high-definition multimedia interface) 972, a USB (universal serial bus) 974, an optical interface 976, or a D-sub (D-subminiature) 978. The interface 970 may be included, for example, in a communication interface 760 illustrated in FIG. 7. Additionally or generally, the interface 970 may include, for example, a mobile high definition link (MHL) interface, a SD card/multi-media card (MMC) interface, or an infrared data association (IrDA) standard interface.

The audio module 980 may convert a sound and an electric signal in dual directions. At least a portion of the audio module 980 may be included, for example, in an input/output interface 740 illustrated in FIG. 7. The audio module 980 may process, for example, sound information that is input or output through a speaker 982, a receiver 984, an earphone 986, or a microphone 988.

According to an embodiment of the present disclosure, the camera module 991 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 995 may manage the power supply of the electronic device 901. Although not illustrated, a power management integrated circuit (PMIC) a charger IC, or a battery or fuel gauge may be included in the power management module 995.

The PMIC may be mounted on an integrated circuit or a SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge may measure, for example, a remaining capacity of the battery 996 and a voltage, current or temperature thereof while the battery is charged. The battery 996 may store or generate electricity, and may supply power to the electronic device 901 using the stored or generated electricity. The battery 996 may include, for example, a rechargeable battery or a solar battery.

The indicator 997 may display a specific state of the electronic device 901 or a portion thereof (e.g., the AP 910), such as a booting state, a message state, a charging state, and the like. The motor 998 may convert an electrical signal into a mechanical vibration. Although not illustrated, a processing device (e.g., a GPU) for supporting a mobile TV may be included in the electronic device 901. The processing device for supporting a mobile TV may process media data according to the standards of DMB, digital video broadcasting (DVB) or media flow.

According to various embodiments of the present disclosure, an electronic device may include a display, a processor configured to output a picture selected by a user through the display, a code generating unit configured to generate an object code based on object information and environment information of the output picture, an analysis unit configured to analyze the object code to identify a region of interest of a user, and a providing unit configured to provide information associated with the identified region of interest to a user or an external device.

According to various embodiments of the present disclosure, the code generating unit may recognize an object through an image processing technique and allocate specific object identification information to the recognized object. The object identification information may be generated by coding information, associated with classification to which the object belongs, and an identification code uniquely allocated to the object.

According to various embodiments of the present disclosure, the analysis unit may include database, a classification unit configured to classify the object code to store the classified result in the database, and a decision unit configured to identify a region of interest of a user, based on the object code and information stored in the database.

According to various embodiments of the present disclosure, the decision unit may identify a region of interest based on at least one of an object selection count, an object selection interval, an object ratio, a saving time, or whether or not of picture deletion. The analysis unit may further include a matching unit configured to identify a region of interest if the object is included in a specific object list. The providing unit may provide additional information associated with the object, based on an interest index of a user on a region of interest. The providing unit may classify the interest index into specific sections and may allocate different additional information to the specific sections.

According to various embodiments of the present disclosure, the object information may include identification information of an object included in the picture and a ratio of the object. The ratio of the object may be a ratio of the object to the picture or a relative ratio between the object and another object of the picture. The environment information may include at least one of a selection time, viewing duration, a saving time, or resolution information.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof The “module” may be a minimum unit for performing one or more functions or a part thereof The “module” may be implemented mechanically or electronically. For example, the “module” may include at least one of an application-specific IC (ASIC) chip, a field-programmable gate array (FPGA), and a programmable-logic device for performing some operations, which are known or will be developed.

According to various embodiments of the present disclosure, at least a portion of an apparatus (e.g., modules or functions thereof) or a method (e.g., operations) according to various embodiments of the present disclosure may be, for example, implemented by instructions stored on a computer-readable storage media in the form of a programmable module. The instruction, when executed by one or more processors (e.g., a processor 120), may cause the one or more processors to perform a function corresponding to the instruction. The computer-readable storage media, for example, may be the memory 130. At least a portion of the programming module may be implemented (e.g., executed), for example, by the processor 120. At least a portion of the programming module may include, for example, modules, programs, routines, sets of instructions, or processes, or the like for performing one or more functions.

A computer-readable recording medium may include hardware, which is configured to store and execute a program instruction (e.g., a programming module), such as a hard disk, a magnetic media such as a floppy disk and a magnetic tape, an optical media such as compact disc read only memory (CD-ROM) and a digital versatile disc (DVD), a magneto-optical media such as a floptical disk, and hardware devices such as read only memory (ROM), random access memory (RAM), and a flash memory. Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a programming module according to an embodiment of the present disclosure may include at least one of the above elements, or a portion of the above elements may be omitted, or additional other elements may be further included. Operations performed by a module, a program module, or other elements according to an embodiment of the present disclosure may be executed sequentially, in parallel, repeatedly, or in a heuristic method. Also, a portion of operations may be executed in different sequences, omitted, or other operations may be added.

According to various embodiments of the present disclosure, a recording medium may store instructions, the instructions, when executed by at least one processor, causing the at least one processor to perform at least one operation including outputting a picture in response to selection of a user, generating an object code based on object information and environment information of the output picture, deciding a region of interest of the user by analyzing the object code, and providing information associated with the decided region of interest.

According to various embodiments of the present disclosure, it may be possible to provide information specialized to a region of interest of a user by exactly determining the region of interest through selection (or enlargement) information of a picture.

Furthermore, a region of interest and interest level of a user may be determined exactly in real time, thereby making it possible to use the determined result for advertisement (e.g., one-to-one marketing or the like).

FIGS. 1-9 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An electronic device comprising:
a display; and
one or more processors configured to:
display an image on the display;
generate an object code associated with an object depicted in the image based on environment information associated with the image;
identify a region of interest based on the object code;
identify an information item associated with the region of interest; and
output the information item.

2. The electronic device of claim 1, wherein the one or more processors are further configured to recognize the object depicted in the image using an image recognition technique and generate an object identifier corresponding to the object.

3. The electronic device of claim 2, wherein the object identifier is uniquely allocated to the object.

4. The electronic device of claim 1, wherein:
the one or more processors are further configured to classify the object to generate a database record; and
the region of interest is identified based on the database record.

5. The electronic device of claim 4, wherein the region of interest is identified based on at least one of an object selection count, an object selection interval, an object ratio, and a saving time.

6. The electronic device of claim 4, wherein the region of interest is identified further based on whether the object is included in a specific object list.

7. The electronic device of claim 1, wherein the one or more processors are further configured to output additional information associated with the object based on the region of interest.

8. The electronic device of claim 1, wherein the object code comprises an identifier corresponding to the object and an indication of a ratio associated with the object.

9. The electronic device of claim 8, wherein the ratio associated with the object includes a ratio of an area in the image that is occupied by the object and a total area of the object.

10. The electronic device of claim 1, wherein the environment information comprises at least one of an indication of an enlargement time, an indication of an enlargement duration, an indication of a saving time, and an indication of a resolution of the image.

11. A method comprising:
displaying an image;
generating, by one or more processors, an object code associated with an object depicted in the image based on environment information associated with the image;
identifying, by the one or more processors, a region of interest based on the object code;
identifying, by the one or more processors, an information item associated with the region of interest; and
outputting the information item.

12. The method of claim 11, further comprising:
recognizing the object depicted in the image using an image recognition technique; and
generating an object identifier corresponding to the object.

13. The method of claim 12, wherein the object identifier is uniquely allocated to the object.

14. The method of claim 11, further comprising classifying the object to generate a database record, wherein the region of interest is further identified based on the database record.

15. The method of claim 14, wherein the region of interest is identified based on at least one of an object selection count, an object selection interval, an object ratio, and a saving time.

16. The method of claim 14, wherein the region of interest is identified further based on whether the object is included in a specific object list.

17. The method of claim 11, further comprising outputting additional information associated with the object based on the region of interest.

18. The method of claim 11, wherein the object code comprises an identifier corresponding to the object and an indication of a ratio associated with the object.

19. The method of claim 18, wherein the ratio associated with the object includes a ratio of an area in the image that is occupied by the object and a total area of the object.

20. The method of claim 11, wherein the environment information comprises at least one of an indication of an enlargement time, an indication of an enlargement duration, an indication of a saving time, and an indication of a resolution of the image.
